(19) United States
(12) Patent Application Publication
(10) Pub. No.: US 2026/0318650 A1
(43) Pub. Date: Oct. 15, 2026

(54) Multi-Color And Multi-Reticle Aiming Optics For Firearms

(71) Applicant: Strike IP LLC, Las Vegas, NV (US)

(72) Inventors: Shanyao Lee, Las Vegas, NV (US); Chien-Yuan Cheng, Las Vegas, NV (US)

(21) Appl. No.: 19/286,184

(22) Filed: Jul. 30, 2025

Related U.S. Application Data
(60) Provisional application No. 63/678,521, filed on Aug. 1, 2024.

(51) Int. Cl. F41G 1/34; F41G 1/38; G02B 27/34

(52) U.S. Cl. CPC F41G 1/345; F41G 1/38; G02B 27/34

(57) ABSTRACT

An apparatus implementable on a firearm includes an aiming optics having a lens, a light-emitting structure and at least one mask. The light-emitting structure includes at least one layer with a first color portion emitting a first light of a first color and a second color portion emitting a second light of a second color. The mask includes first and second mask portions. The first mask portion partially covers the first light emitted by the first color portion to result in a first reticle in the first color reflected on the lens and visible to a user. The second mask portion partially covers the second light emitted by the second color portion to result in a second reticle in the second color reflected on the lens and visible to the user. The first reticle provides an aiming function, and the second reticle provides a different function other than aiming.

### CROSS REFERENCE TO RELATED PATENT APPLICATION(S)

The present disclosure claims the priority benefit of U.S. Provisional Patent Application No. 63/678,521, filed 1 Aug. 2024, the content of which herein being incorporated by reference in its entirety.

### TECHNICAL FIELD

The present disclosure is generally related to firearm accessories and, more particularly, to a multi-color and multi-reticle aiming optics for firearms.

### BACKGROUND

Unless otherwise indicated herein, approaches described in this section are not prior art to the claims listed below and are not admitted as prior art by inclusion in this section.

Conventional aiming optics for firearms tend to be limited to displaying a reticle of one single color. The introduction of organic light-emitting diode (OLED) technology allows the presentation of various colors by a displaying panel. However, due to constraints imposed by lens coatings, zeroing reticles of different colors on the same optics would inevitably introduce an issue of color shift. For instance, when zeroing with a red-colored reticle on an OLED and later switching to a green-colored reticle, the green-colored reticle may shift relative to the red-colored reticle, thereby rendering the green-colored reticle unsuitable for precise aiming. Therefore, there is a need for a multi-color and multi-reticle aiming optics for firearms.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In view of the aforementioned issues, an objective of the present disclosure is to propose innovative designs of a multi-color and multi-reticle aiming optics for firearms. It is believed that the proposed designs can avoid or otherwise minimize aforementioned issue associated with existing accessories attachment designs. For instance, under one or more of the schemes proposed herein, one specific color may be utilized for aiming during the zeroing process, while remaining colored reticles may serve as references and for information display purposes. These references may include measurement lines, quick-focus reference lines, bullet drop lines, and more.

In one aspect, an apparatus implementable on a firearm (e.g., a pistol, rifle, carbine or shotgun) may include an aiming optics having a lens, a light-emitting structure, and a plurality of masks. The light-emitting structure may include at least a first layer configured to emit a first light of a first color and a second layer configured to emit a second light of a second color. The plurality of masks may include at least a first mask and a second mask such that: (a) the first mask partially covers or obstructs the first light emitted by the first layer to result in a first reticle in the first color reflected on the lens and visible to a user; and (b) the second mask partially covers or obstructs the second light emitted by the second layer to result in a second reticle in the second color reflected on the lens and visible to the user. In operation, the first reticle may provide an aiming function, and the second reticle may provide a different function other than aiming.

In another aspect, an apparatus implementable on a firearm (e.g., a pistol, rifle, carbine or shotgun) may include an aiming optics having a lens, a light-emitting structure, and at least one mask. The light-emitting structure may include at least one layer with a first color portion configured to emit a first light of a first color and a second color portion configured to emit a second light of a second color. The at least one mask may include a first mask portion and a second mask portion such that: (a) the first mask portion partially covers or obstructs the first light emitted by the first color portion to result in a first reticle in the first color reflected on the lens and visible to a user; and (b) the second mask portion partially covers or obstructs the second light emitted by the second color portion to result in a second reticle in the second color reflected on the lens and visible to the user. In operation, the first reticle may provide an aiming function, and the second reticle may provide a different function other than aiming.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 is a diagram of various components of an example apparatus under a proposed scheme in accordance with the present disclosure.

FIG. 2 is a diagram of an example scenario under a proposed scheme in accordance with the present disclosure.

FIG. 3 is a diagram of an example scenario under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

The position terms used in the present disclosure, such as “front”, “forward”, “rear”, “back”, “top”, “bottom”, “left”, “right”, “head”, “tail” or the like assume a firearm in the normal firing position, with the firearm being in a position in which the longitudinal axis of the barrel of the firearm runs generally horizontally and the direction of firing points “forward” away from the operator or user of the firearm. The same convention applies for the direction statements used herein.

As used herein, the terms “proximal” and “proximally” may denote “forward” and “forwardly” with respect to the firearm, and the terms “distal” and “distally” may denote “rearward” and “rearwardly” with respect to the firearm. As used herein, the verb “to comprise” in this description, claims, and other conjugations are used in its non-limiting sense to mean those items following the word are included, but items not specifically mentioned are not excluded. As used herein, the word “forward” means moving in the direction that the projectile moves during firing a firearm. As used herein, the word “proximal” means closer to the reference point, in this case, the shooter. As used herein, the word “distal” means farther to the reference point, in this case, the shooter. Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5). All dimensions given herein are by way of examples to better illustrate the present disclosure embodiments and shall not be construed to limit the dimensions of the present disclosure embodiments to the given numeric values.

### Overview

Under various proposed schemes in accordance with the present disclosure, an aiming optics apparatus may be configured with multiple colors and multiple reticles on a same OLED structure or light-emitting diode (LED) structure. The OLED (or LED) structure may be configured with multiple color layers with each color layer showing different color(s). Alternatively, the OLED (or LED) structure may be configured with one single layer (on a same chip) configured to show different colors (e.g., two colors) side by side (e.g., the single layer having a first color portion and a second color portion to show two colors side by side). A mask coating may be applied on each color layer or each color portion to create or otherwise result in visible reticles of different colors. The reticles of different colors may be displayed at the same time (e.g., simultaneously) or individual (e.g., one at a time) or in combination (e.g., with two or more being displayed together). Under the proposed schemes, among the reticles of different colors, a respective reticle of a chosen color may be the one and only one reticle that may be zeroed for target aiming, while remaining reticle(s) of other color(s) may be utilized for reference and to display information, instead of aiming.

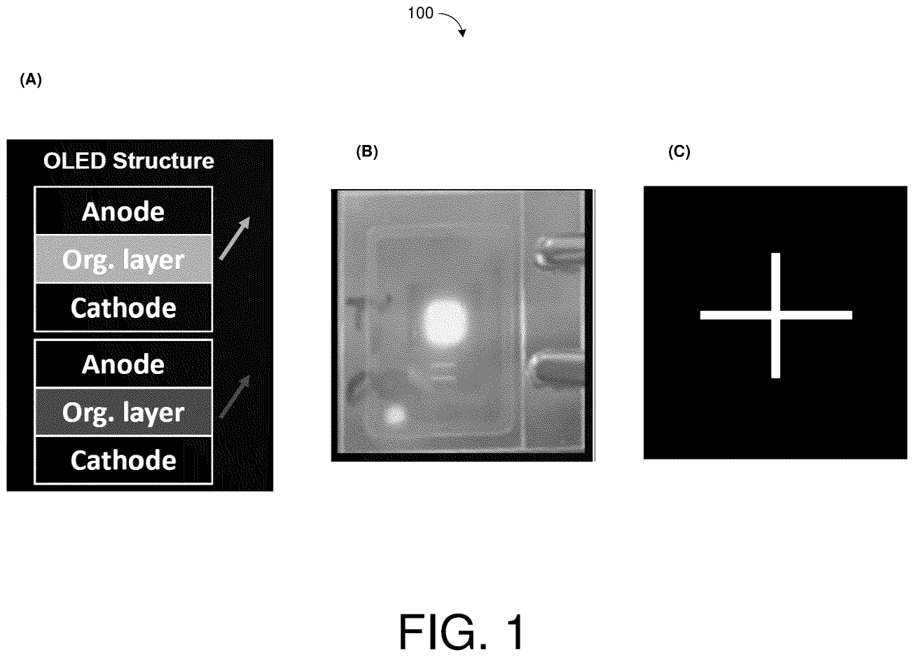

FIG. 1 illustrates various components of an example apparatus 100 under a proposed scheme in accordance with the present disclosure. Under the proposed scheme, an aiming optics apparatus 100 may be configured with a light-emitting structure (e.g., an OLED structure or a LED structure) with two layers configured to show or emit two colors, or a single layer with a first color portion and a second color portion side by side to show or emit two colors, as shown in part (A) of FIG. 1. In one implementation, a first layer of the two layers of the light-emitting structure may be configured or otherwise controlled to display or emit a green light (and thus herein interchangeably referred to as the “green color layer”) as shown in part (B) of FIG. 1, and a second layer of the two layers of the light-emitting structure may be configured or otherwise controlled to display or emit a red light (and thus herein interchangeably referred to as the “red color layer”). In another implementation, a first portion of a single layer of the light-emitting structure may be configured or otherwise controlled to display or emit a green light (and thus herein interchangeably referred to as the “green color portion”) as shown in part (B) of FIG. 1, and a second portion of the single layer of the light-emitting structure may be configured or otherwise controlled to display or emit a red light (and thus herein interchangeably referred to as the “red color portion”). As shown in part (C) of FIG. 1, a black or dark mask may be added on top of each light source with a cutout or empty space having the shape of a respective reticle to generate reticles when lights of different colors are incident on the mask. Each reticles thus generated may be reflected on a lens of the aiming optics apparatus 100 for eyes of a user to see. For instance, a mask may be added on the green color layer (or green color portion) to generate a green-colored reticle.

Accordingly, reticles may be designed on the two layers of the OLED structure (or LED structure) or the two color portions of the single layer of the OLED structure (or LED structure). For instance, with a respective mask partially covering or otherwise obstructing the red light emitted by the red color layer (or red color portion of the single layer), the red color layer (or red color portion) may be utilized to generate reticles in a red color (herein interchangeably referred to as the “red color reticles”). Similarly, with a respective mask partially covering or otherwise obstructing the green light emitted by the green color layer (or green color portion of the single layer), the green color layer (or green color portion) may be utilized to generate reticles in a green color (herein interchangeably referred to as the “green color reticles”).

Notably, while the red and green color reticles may be concentric on the OLED (or LED), after the (O)LED's reticles are reflected onto the lens of the aiming optics apparatus 100 the red and green color reticles may no longer be concentric due to shifting. The shift in either or both of the red and green color reticles may be due to the lens's coating having a different reflection ratio with respect to different electromagnetic wavelengths. Since lights of green color and red color have different electromagnetic wavelengths, objects in green color and objects in red color may be displayed or visible differently in the eyes of the user. However, this is undesirable for aiming. For example, when only the red color reticle is turned on and zeroed to a target before turning on the green color reticle, after the green color reticle is turned on the center of the green color reticle may be shifted relative to the center of the red color reticle. This may result in the point of impact of a fired shot or bullet being shifted relative to an aiming point.

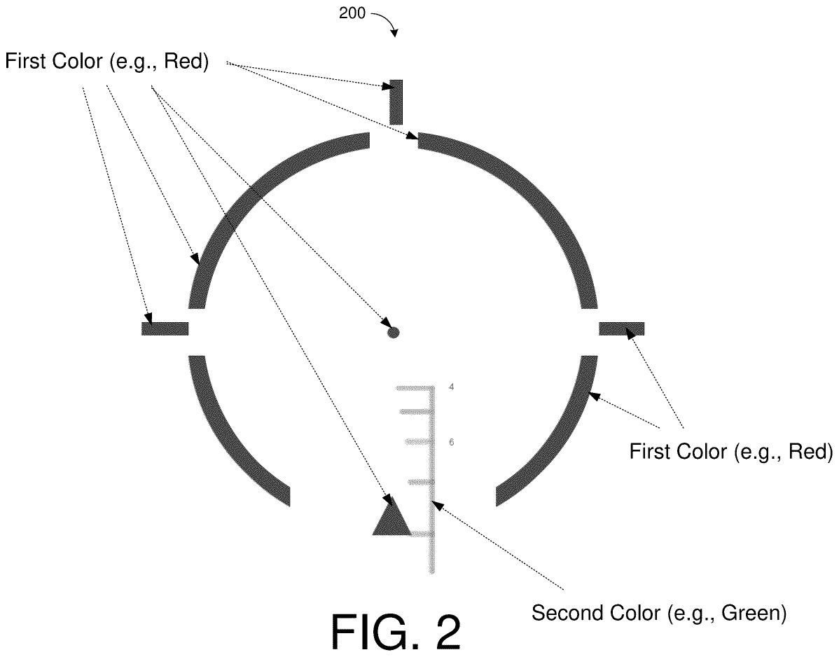

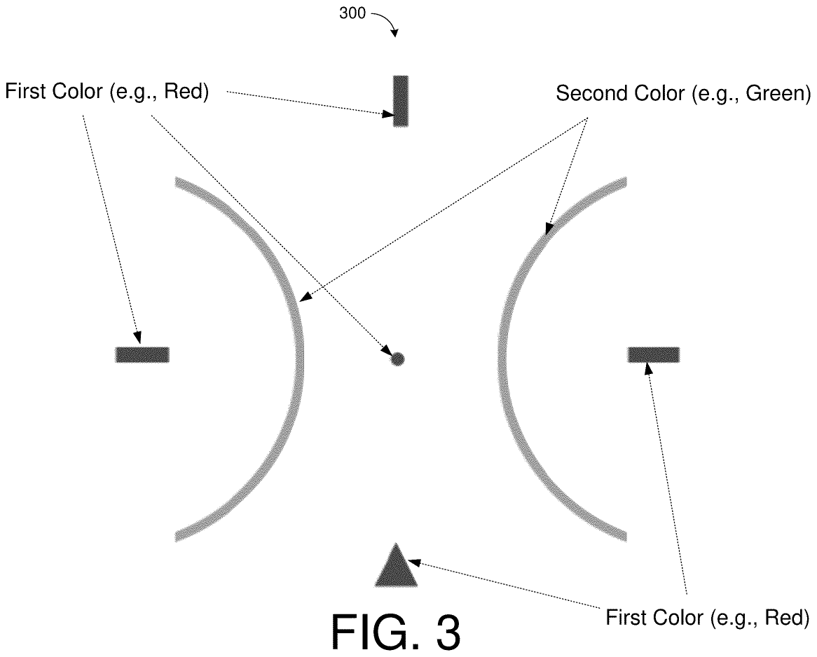

FIG. 2 illustrates an example scenario 200 under a proposed scheme in accordance with the present disclosure. FIG. 3 illustrates an example scenario 300 under a proposed scheme in accordance with the present disclosure. To address the above-described issue due to shifting, under a proposed scheme in accordance with the present disclosure, reticles of one color among the different colors may be chosen for aiming while reticles of other color(s) may be used for reference. For instance, as shown in FIG. 2, the color of red (and, hence, red color reticles) may be chosen and used for aiming (e.g., by displaying or otherwise showing geometric shapes resembling at least a portion of a concentric ring and an aiming point at the center) while the color of green (and, hence, green color reticles) may be chosen for distance measurement (e.g., by displaying or otherwise showing tiered markings calibrated to provide bullet drop compensation (BDC) for different distances). As another example, as shown in FIG. 3, the color of red (and, hence, red color reticles) may be chosen and used for aiming (e.g., by displaying or otherwise showing geometric shapes resembling at least an aiming point at the center and markings and/or shapes guiding the focus of the eyes of the user to the aiming point) while the color of green (and, hence, green color reticles) may be chosen for focus reference (e.g., by displaying or otherwise showing geometric shapes resembling two convex curves to the left and right of the aiming point).

### Example Implementations

In view of the above, the proposed designs of a multi-color and multi-reticle aiming optics for firearms may be implemented in many ways. For illustrative purposes and without limiting the scope of the present disclosure, a few example implementations of the proposed design are described below.

In one aspect, an apparatus implementable on a firearm (e.g., a pistol, rifle, carbine or shotgun) may include an aiming optics having a lens, a light-emitting structure, and a plurality of masks. The light-emitting structure may include at least a first layer configured to emit a first light of a first color and a second layer configured to emit a second light of a second color. The plurality of masks may include at least a first mask and a second mask such that: (a) the first mask partially covers or obstructs the first light emitted by the first layer to result in a first reticle in the first color reflected on the lens and visible to a user; and (b) the second mask partially covers or obstructs the second light emitted by the second layer to result in a second reticle in the second color reflected on the lens and visible to the user. In operation, the first reticle may provide an aiming function, and the second reticle may provide a different function other than aiming.

In some implementations, the light-emitting structure may include an OLED structure or LED structure.

In some implementations, the first reticle may include geometric shapes resembling at least a portion of a concentric ring and an aiming point. In some implementations, the second reticle may include tiered markings providing a distance measurement function. Alternatively, the second reticle may include geometric shapes resembling two convex curves to left and right sides of the aiming point to provide a focus reference function.

In some implementations, the first reticle may include geometric shapes resembling at least an aiming point and markings or shapes guiding a focus of eyes of the user to the aiming point. In some implementations, the second reticle may include tiered markings providing a distance measurement function. Alternatively, the second reticle may include geometric shapes resembling two convex curves to left and right sides of the aiming point to provide a focus reference function.

In some implementations, one of the first and second colors may be red, and the other of the first and second colors may be green.

In another aspect, an apparatus implementable on a firearm (e.g., a pistol, rifle, carbine or shotgun) may include an aiming optics having a lens, a light-emitting structure, and at least one mask. The light-emitting structure may include at least one layer with a first color portion configured to emit a first light of a first color and a second color portion configured to emit a second light of a second color. The at least one mask may include a first mask portion and a second mask portion such that: (a) the first mask portion partially covers or obstructs the first light emitted by the first color portion to result in a first reticle in the first color reflected on the lens and visible to a user; and (b) the second mask portion partially covers or obstructs the second light emitted by the second color portion to result in a second reticle in the second color reflected on the lens and visible to the user. In operation, the first reticle may provide an aiming function, and the second reticle may provide a different function other than aiming.

In some implementations, the light-emitting structure may include an OLED structure or LED structure.

In some implementations, the first reticle may include geometric shapes resembling at least a portion of a concentric ring and an aiming point. In some implementations, the second reticle may include tiered markings providing a distance measurement function. Alternatively, the second reticle may include geometric shapes resembling two convex curves to left and right sides of the aiming point to provide a focus reference function.

In some implementations, the first reticle may include geometric shapes resembling at least an aiming point and markings or shapes guiding a focus of eyes of the user to the aiming point. In some implementations, the second reticle may include tiered markings providing a distance measurement function. Alternatively, the second reticle may include geometric shapes resembling two convex curves to left and right sides of the aiming point to provide a focus reference function.

In some implementations, one of the first and second colors may be red, and the other of the first and second colors may be green.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus implementable on a firearm, comprising:
an aiming optics comprising:
a lens;
a light-emitting structure comprising at least one layer with a first color portion configured to emit a first light of a first color and a second color portion configured to emit a second light of a second color; and
at least one mask comprising a first mask portion and a second mask portion such that:
the first mask portion partially covers or obstructs the first light emitted by the first color portion to result in a first reticle in the first color reflected on the lens and visible to a user; and
the second mask portion partially covers or obstructs the second light emitted by the second color portion to result in a second reticle in the second color reflected on the lens and visible to the user, wherein:
the first reticle provides an aiming function, and
the second reticle provides a different function other than aiming.

2. The apparatus of claim 1, wherein the light-emitting structure comprises an organic light-emitting diode (OLED) structure.

3. The apparatus of claim 1, wherein the light-emitting structure comprises a light-emitting diode (LED) structure.

4. The apparatus of claim 1, wherein the first reticle comprises geometric shapes resembling at least a portion of a concentric ring and an aiming point.

5. The apparatus of claim 4, wherein the second reticle comprises tiered markings providing a distance measurement function.

6. The apparatus of claim 4, wherein the second reticle comprises geometric shapes resembling two convex curves to left and right sides of the aiming point to provide a focus reference function.

7. The apparatus of claim 1, wherein the first reticle comprises geometric shapes resembling at least an aiming point and markings or shapes guiding a focus of eyes of the user to the aiming point.

8. The apparatus of claim 7, wherein the second reticle comprises tiered markings providing a distance measurement function.

9. The apparatus of claim 7, wherein the second reticle comprises geometric shapes resembling two convex curves to left and right sides of the aiming point to provide a focus reference function.

10. The apparatus of claim 1, wherein one of the first and second colors is red, and wherein another of the first and second colors is green.

11. An apparatus implementable on a firearm, comprising:
an aiming optics comprising:
a lens;
a light-emitting structure comprising at least a first layer configured to emit a first light of a first color and a second layer configured to emit a second light of a second color; and
a plurality of masks comprising at least a first mask and a second mask such that:
the first mask partially covers or obstructs the first light emitted by the first layer to result in a first reticle in the first color reflected on the lens and visible to a user; and
the second mask partially covers or obstructs the second light emitted by the second layer to result in a second reticle in the second color reflected on the lens and visible to the user,
wherein:
the first reticle provides an aiming function, and
the second reticle provides a different function other than aiming.

12. The apparatus of claim 11, wherein the light-emitting structure comprises an organic light-emitting diode (OLED) structure.

13. The apparatus of claim 11, wherein the light-emitting structure comprises a light-emitting diode (LED) structure.

14. The apparatus of claim 11, wherein the first reticle comprises geometric shapes resembling at least a portion of a concentric ring and an aiming point.

15. The apparatus of claim 14, wherein the second reticle comprises tiered markings providing a distance measurement function.

16. The apparatus of claim 14, wherein the second reticle comprises geometric shapes resembling two convex curves to left and right sides of the aiming point to provide a focus reference function.

17. The apparatus of claim 11, wherein the first reticle comprises geometric shapes resembling at least an aiming point and markings or shapes guiding a focus of eyes of the user to the aiming point.

18. The apparatus of claim 17, wherein the second reticle comprises tiered markings providing a distance measurement function.

19. The apparatus of claim 17, wherein the second reticle comprises geometric shapes resembling two convex curves to left and right sides of the aiming point to provide a focus reference function.

20. The apparatus of claim 11, wherein one of the first and second colors is red, and wherein another of the first and second colors is green.
